(19) United States
(12) Patent Application Publication
(10) Pub. No.: US 2016/0231612 A1
(43) Pub. Date: Aug. 11, 2016

(54) LIQUID CRYSTAL DISPLAY MODULE FIXING STRUCTURE

(71) Applicant: SHENZHEN CHINA STAR OPTOELECTRONICS TECHNOLOGY CO. LTD., Shenzhen, Guangdong (CN)

(72) Inventor: Yanxue ZHANG, Shenzhen, Guangdong (CN)

(73) Assignee: Shenzhen China Star Optoelectronics Technology Co. Ltd., Shenzhen, Guangdong (CN)

(21) Appl. No.: 14/378,618

(22) PCT Filed: Jul. 18, 2014
(86) PCT No.: PCT/CN2014/082532

§ 371 Date: Aug. 13, 2014

(30) Foreign Application Priority Data
Jul. 1, 2014 (CN) 201410312796.4

(51) Int. Cl. G02F 1/1333

(52) U.S. Cl. CPC G02F 1/133308; G02F 2001/133328; G02F 2201/46; G02F 2001/133322

(57) ABSTRACT

The present invention provides a liquid crystal display module fixing structure for fixing a liquid crystal display module. The liquid crystal display module includes two side surfaces formed on two side edges thereof and two end surfaces formed on two end edges thereof. The liquid crystal display module fixing structure includes: two first fixing pieces and two second fixing pieces. The first fixing pieces each include an elongate strip like first mounting section and first fixing sections respectively formed on two ends of the first mounting section. The second fixing pieces each include an elongate strip like second mounting section and second fixing sections respectively formed on two ends of the second mounting section. The first mounting sections of the two first fixing pieces are respectively mounted to the two sides of the liquid crystal display module. The first fixing sections are mounted to the two end faces of the liquid crystal display module. The second mounting sections of the two second fixing pieces are respectively mounted to the two ends of the liquid crystal display module. The second fixing sections are respectively positioned against the two side faces of the liquid crystal display module.

### BACKGROUND OF THE INVENTION

1. Field of the Invention

The present invention relates to the field of liquid crystal displaying, and in particular to a liquid crystal display module fixing structure.

2. The Related Arts

Liquid crystal displays (LCDs) have a variety of advantages, such as thin device body, low power consumption, and being free of radiation, and are thus of wide applications, including mobile phones, personal digital assistants (PDAs), computer screens, and notebook computer screens.

Most of the liquid crystal displays that are currently available in the market are backlighting liquid crystal displays, which comprise a backlight module, a liquid crystal panel coupled to the backlight module, and a bezel that fixes the liquid crystal panel and the backlight module.

The principle of operation of a liquid crystal panel is that with liquid crystal molecules interposed between two parallel glass substrates and a number of vertical and horizontal tiny electrical wires arranged between the two glass substrates, application of electricity is made to control the liquid crystal molecules to change direction in order to refract out the light emitting from the backlight module for generation of images. Since the liquid crystal panel itself does not emit light, light must be provided from the backlight module in order to normally display images. The backlight modules can be classified in two types, namely a side-edge backlight module and a direct backlight module, according to the site where light gets incident. The side-edge backlight module comprises an LED (Light-Emitting Diode) light bar, serving as a backlight source, which is arranged at an edge of a backplane to be located rearward of one side of the liquid crystal panel. The LED light bar emits light that enters a light guide plate (LGP) through a light incident face at one side of the light guide plate and is projected out of a light exit face of the light guide plate, after being reflected and diffused, to pass through an optic film assembly so as to form a planar light source for the liquid crystal panel.

As shown in FIG. 1, in the conventional liquid crystal display modules, a bezel 100 is often arranged to fix a liquid crystal display panel. When the modules have been shipped to a client side, a television front housing will be additionally assembled thereto. For a liquid crystal television product, the television front housing also provides a function of fixing the liquid crystal display panel. With such an arrangement, the module bezel 100 becomes a part that can be omitted. However, when the modules are to be shipped, without being fixed by the front bezel 100, no secured shipment of the modules can be achieved. If the liquid crystal display panel and the backlight module of the module are shipped separately, an increase of expenses of packaging and transportation will result.

### SUMMARY OF THE INVENTION

An object of the present invention is to provide a liquid crystal display module fixing structure, which has the advantages of efficient assembling and dismounting and is useful for fixing a liquid crystal display module for substitute of a bezel to achieve the purpose of omitting the bezel. The fixing structure can realize fixation of the liquid crystal display module and ensure the security of the liquid crystal display module during shipment.

To achieve the above object, the present invention provides a liquid crystal display module fixing structure, which is provided for fixing a liquid crystal display module, wherein the liquid crystal display module comprises two side surfaces formed on two side edges thereof and two end surfaces formed on two end edges thereof. The liquid crystal display module fixing structure comprises: two first fixing pieces and two second fixing pieces. The first fixing pieces each comprise an elongate strip like first mounting section and first fixing sections respectively formed on two ends of the first mounting section. The second fixing pieces each comprise an elongate strip like second mounting section and second fixing sections respectively formed on two ends of the second mounting section. The first mounting sections of the two first fixing pieces are respectively mounted to the two sides of the liquid crystal display module. The first fixing sections are mounted to the two end faces of the liquid crystal display module. The second mounting sections of the two second fixing pieces are respectively mounted to the two ends of the liquid crystal display module. The second fixing sections are respectively positioned against the two side faces of the liquid crystal display module.

The first fixing sections each comprise a first through hole formed therein to receive the extension of a bolt therethrough so as to fix the first fixing sections to end faces of the two ends of the liquid crystal display module. The two second fixing sections of each of the second fixing pieces are respectively positioned against side faces of the two sides of the liquid crystal display module. The first fixing pieces press down against the second fixing pieces so as to fix the second fixing pieces to the liquid crystal display module.

The liquid crystal display module comprises a backplane. The backplane is provided with threaded holes for mounting a bezel. The bolts that extend through the first through holes threadingly engage the corresponding threaded holes of the backplane.

The first mounting sections each comprise a first cushion member to provide a cushioning effect when positioned on the liquid crystal display module. The first cushion member is located at the same side of the first mounting section as the first fixing sections are. The second mounting sections are each provided with a second cushion member to provide a cushioning effect when positioned on the liquid crystal display module. The second cushion member is located at the same side of the second mounting section as the second fixing sections are.

The first cushion member is made in the form of an elongate strip and is mounted, through adhesive bonding, to a middle portion of the first mounting section. The second cushion member is made in the form of an elongate strip and is mounted, through adhesive bonding, to a middle portion of the second mounting section.

The first fixing pieces and the second fixing pieces are each in the form of an n-shaped structure by machining a thin plate.

The thin plate is made of aluminum material, steel material, or Bakelite.

The liquid crystal display module fixing structure further comprises a third fixing piece. The third fixing piece comprises an elongate strip like third mounting section and third fixing sections respectively formed on two ends of the third mounting section to be mounted to a middle portion of the liquid crystal display module and fixed to the two ends of the liquid crystal display module.

The efficacy of the present invention is that the present invention provides a liquid crystal display module fixing structure, which is used to fix a liquid crystal display module by replacing a bezel so as to achieve the purpose of omitting the bezel and also provide advantages of efficient assembling and dismounting. The fixing structure realizes fixation of a liquid crystal display module and ensures the security of the liquid crystal display module during shipment. Further, since the fixing structure is dismountable, repeated recycling for re-use can be achieved to thereby saving the manufacturing cost. A liquid crystal display module includes the fixing structure mounted thereto, after shipped to a whole device manufacturing line, allows for efficient dismounting of the fixing structure for sequentially mounting a television front housing.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a perspective view showing a conventional bezel of a liquid crystal display module;

FIG. 2 is a perspective view showing a first embodiment of a liquid crystal display module fixing structure according to the present invention;

FIG. 3 is a perspective view showing a first fixing piece of the fixing structure of FIG. 2;

FIG. 4 is a perspective view showing a second fixing piece of the fixing structure of FIG. 2;

FIG. 5 is a partial enlarged view of the fixing structure of FIG. 2;

FIG. 6 is a perspective view showing a liquid crystal display module in which the fixing structure of FIG. 2 is mounted;

FIG. 7 is a partial enlarged view of the liquid crystal display module of FIG. 6;

FIG. 8 is a perspective view showing a second embodiment of the fixing structure of the liquid crystal display module according to the present invention;

FIG. 9 is a perspective view showing a third fixing piece of the fixing structure of the liquid crystal display module of the present invention; and

FIG. 10 is a perspective view showing a liquid crystal display module in which the fixing structure of FIG. 8 is mounted.

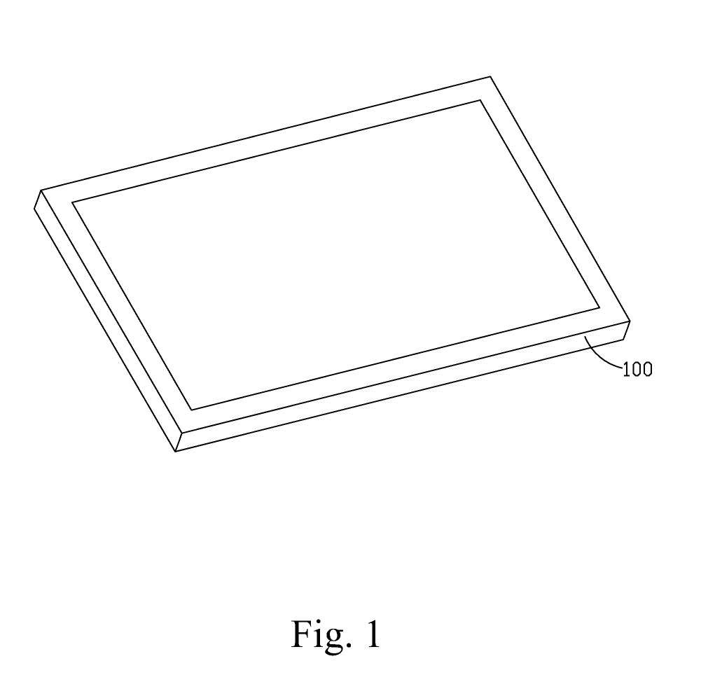

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

The present invention provides a liquid crystal display module fixing structure, which is used to fix a liquid crystal display module. The liquid crystal display module has two side surfaces formed on two side edges thereof and two end surfaces formed on two end edges thereof. The fixing structure of the present invention can be used to replace a bezel of a liquid crystal module and provides advantages of efficient assembling and dismounting.

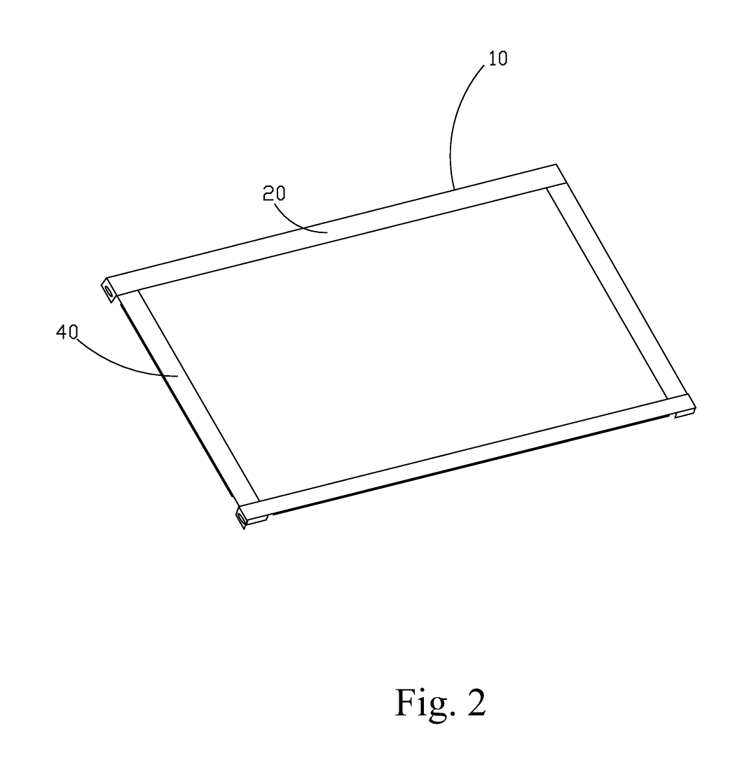

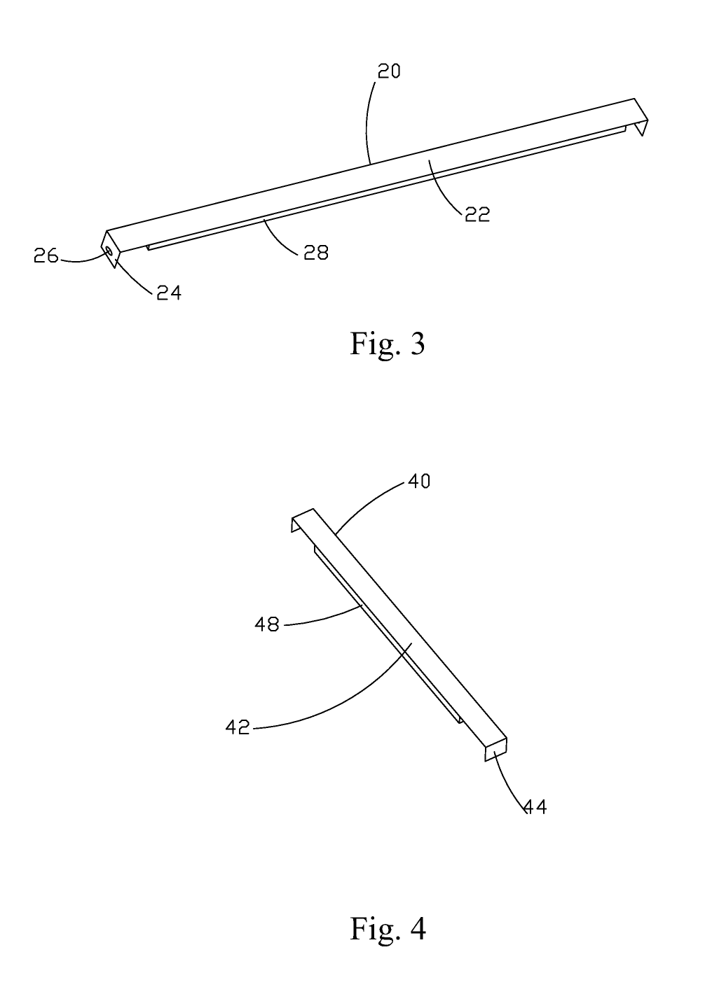

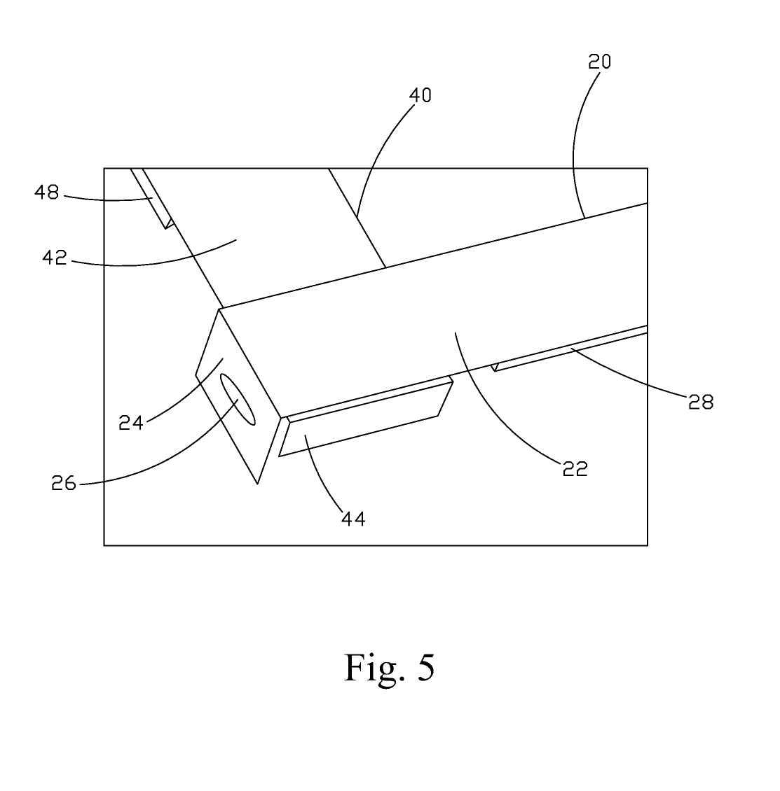

Referring to FIGS. 2-7, a first embodiment of the present invention is shown. In the instant embodiment, the present invention provides a liquid crystal display module fixing structure 10, which comprises: two first fixing pieces 20 and two second fixing pieces 40.

The first fixing pieces 20 each comprise an elongate strip like first mounting section 22 and first fixing sections 24 respectively formed on two ends of the first mounting section 22. The second fixing pieces 40 each comprise an elongate strip like second mounting section 42 and second fixing sections 44 respectively formed on two ends of the second mounting section 42. The first mounting sections 22 of the two first fixing pieces 20 are respectively mounted to the two sides of the liquid crystal display module. The first fixing sections 24 are mounted to the two end faces of the liquid crystal display module. The second mounting sections 42 of the two second fixing pieces 40 are respectively mounted to the two ends of the liquid crystal display module. The second fixing sections 44 are respectively positioned against the two side faces of the liquid crystal display module.

The first fixing sections 24 each comprise a first through hole 26 formed therein to receive the extension of a bolt therethrough so as to fix the first fixing sections 24 to end faces of the two ends of the liquid crystal display module. The two second fixing sections 44 of each of the second fixing pieces 40 are respectively positioned against the side faces of the two sides of the liquid crystal display module. The first fixing pieces 20 press down against the second fixing pieces 40 so as to fix the second fixing pieces 40 to the liquid crystal display module.

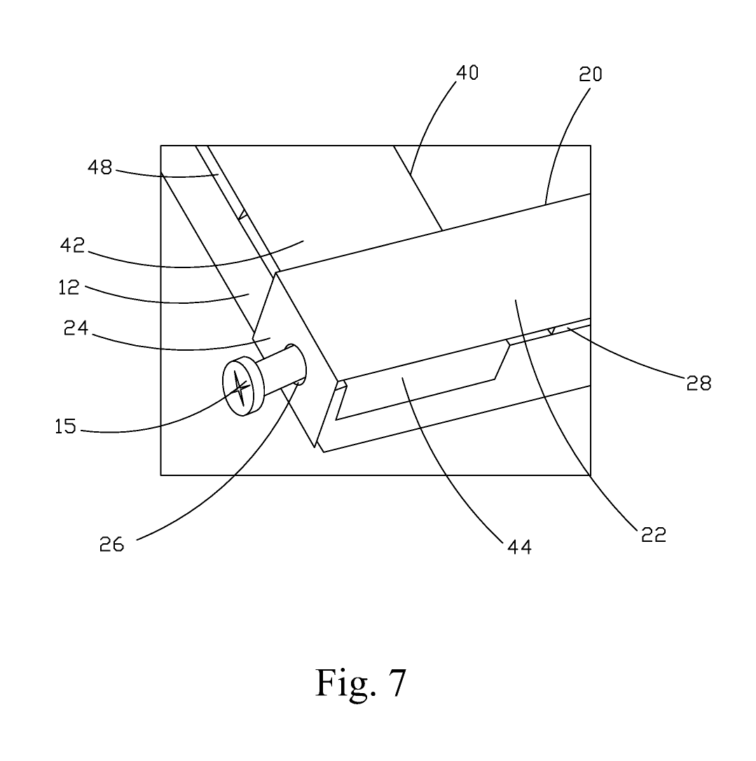

As shown in FIG. 7, the liquid crystal display module comprises a backplane 12. The backplane 12 is provided with threaded holes (not shown) for mounting a bezel. The bolts 15 that extend through the first through holes 26 threadingly engage the corresponding threaded holes of the backplane.

The first mounting sections 22 each comprise a first cushion member 28 to provide a cushioning effect when positioned on the liquid crystal display module. The first cushion member 28 is located at the same side of the first mounting section 22 as the first fixing sections 24 are. The second mounting sections 42 are each provided with a second cushion member 48 to provide a cushioning effect when positioned on the liquid crystal display module. The second cushion member 48 is located at the same side of the second mounting section 42 as the second fixing sections 44 are.

The first cushion member 28 is made in the form of an elongate strip and is mounted, through adhesive bonding, to a middle portion of the first mounting section 22. The second cushion member 48 is made in the form of an elongate strip and is mounted, through adhesive bonding, to a middle portion of the second mounting section 42.

The first fixing pieces 20 and the second fixing pieces 40 are each in the form of an n-shaped structure by machining a thin plate. The thin plate can be made of aluminum material, steel material, or Bakelite.

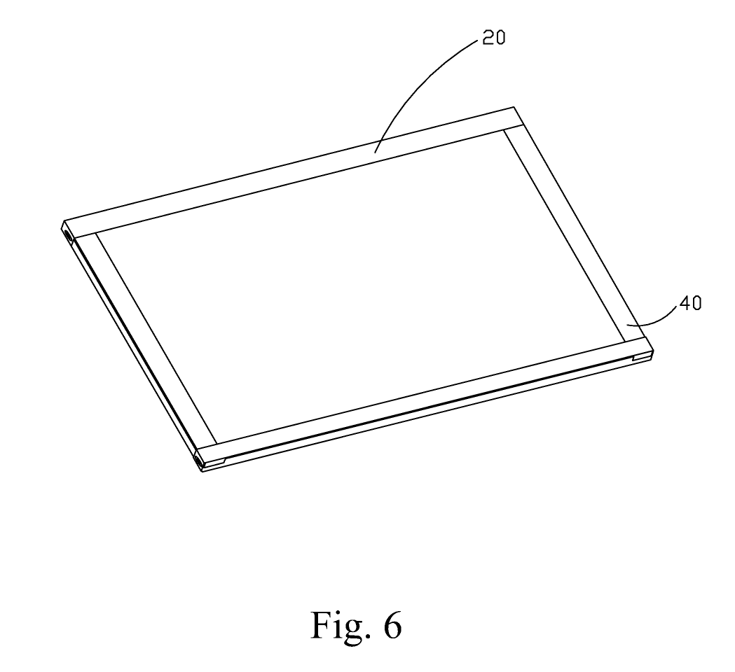

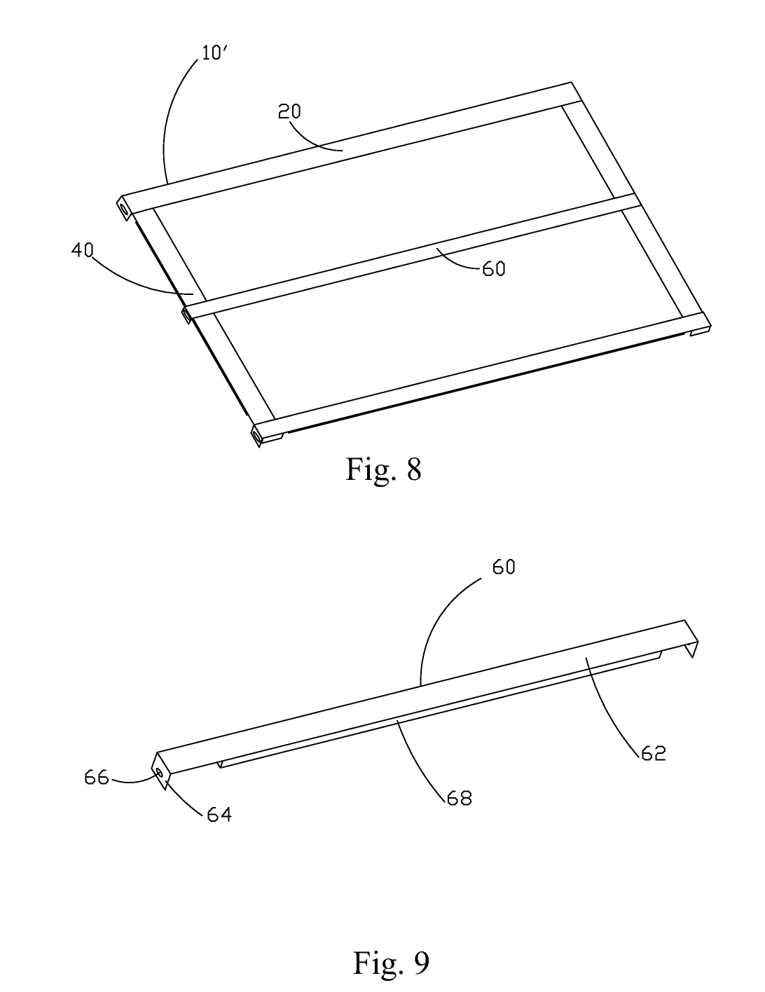

Referring to FIGS. 8-10, a second embodiment of the present invention is shown. In the instant embodiment, the present invention provides a liquid crystal display module fixing structure 10′, and when compared with the first embodiment, the fixing structure 10′ additionally comprises a third fixing piece 60. Referring to FIG. 6, the third fixing piece 60 comprises an elongate strip like third mounting section 62 and third fixing sections 64 respectively formed on two ends of the third mounting section 62 to be mounted to a middle portion of the liquid crystal display module and fixed to the two ends of the liquid crystal display module.

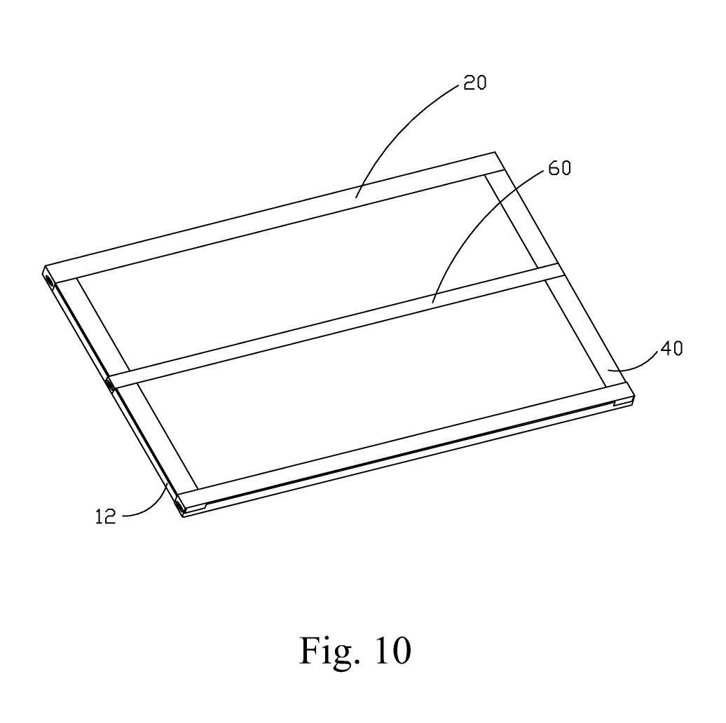

As shown in FIG. 10, the third fixing sections 64 each comprise a second through hole 66 formed therein to receive the extension of a bolt (not shown) therethrough so as to fix the third fixing sections 64 to the end faces of the two ends of the liquid crystal display module. The third fixing piece 60 presses down against the second fixing pieces 40 so as to further secure the second fixing pieces 40 to the liquid crystal display module. The liquid crystal display module comprises a backplane 12. The backplane 12 is provided with threaded holes (not shown) for mounting a bezel. The bolts that extend through the second through holes 66 threadingly engage the corresponding threaded holes of the backplane 12.

The third mounting section 62 comprises a third cushion member 68 to provide a cushioning effect when positioned on the liquid crystal display module. The third cushion member 68 is located at the same side of the third mounting section 62 as the third fixing sections 64 are. The third cushion member 68 is made in the form of an elongate strip and is mounted, through adhesive bonding, to a middle portion of the third mounting section 62.

The third fixing piece 60 is in the form of an n-shaped structure by machining a thin plate. The thin plate can be made of aluminum material, steel material, or Bakelite.

In summary, the present invention provides a liquid crystal display module fixing structure, which is used to fix a liquid crystal display module by replacing a bezel so as to achieve the purpose of omitting the bezel and also provide advantages of efficient assembling and dismounting. The fixing structure realizes fixation of a liquid crystal display module and ensures the security of the liquid crystal display module during shipment. Further, since the fixing structure is dismountable, repeated recycling for re-use can be achieved to thereby saving the manufacturing cost. A liquid crystal display module includes the fixing structure mounted thereto, after shipped to a whole device manufacturing line, allows for efficient dismounting of the fixing structure for sequentially mounting a television front housing.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A liquid crystal display module fixing structure, which is configured for fixing a liquid crystal display module that comprises two side surfaces formed on two side edges thereof and two end surfaces formed on two end edges thereof, comprising: two first fixing pieces and two second fixing pieces, the first fixing pieces each comprising an elongate strip like first mounting section and first fixing sections respectively formed on two ends of the first mounting section, the second fixing pieces each comprising an elongate strip like second mounting section and second fixing sections respectively formed on two ends of the second mounting section, the first mounting sections of the two first fixing pieces being respectively mounted to the two sides of the liquid crystal display module, the first fixing sections being mounted to the two end faces of the liquid crystal display module, the second mounting sections of the two second fixing pieces being respectively mounted to the two ends of the liquid crystal display module, the second fixing sections being respectively positioned against the two side faces of the liquid crystal display module.

2. The liquid crystal display module fixing structure as claimed in claim 1, wherein the first fixing sections each comprise a first through hole formed therein to receive the extension of a bolt therethrough so as to fix the first fixing sections to end faces of the two ends of the liquid crystal display module, the two second fixing sections of each of the second fixing pieces being respectively positioned against side faces of the two sides of the liquid crystal display module, the first fixing pieces pressing down against the second fixing pieces so as to fix the second fixing pieces to the liquid crystal display module.

3. The liquid crystal display module fixing structure as claimed in claim 2, wherein the liquid crystal display module comprises a backplane, the backplane being provided with threaded holes for mounting a bezel, the bolts that extend through the first through holes threadingly engaging the corresponding threaded holes of the backplane.

4. The liquid crystal display module fixing structure as claimed in claim 1, wherein the first mounting sections each comprise a first cushion member to provide a cushioning effect when positioned on the liquid crystal display module, the first cushion member being located at the same side of the first mounting section as the first fixing sections are, the second mounting sections being each provided with a second cushion member to provide a cushioning effect when positioned on the liquid crystal display module, the second cushion member being located at the same side of the second mounting section as the second fixing sections are.

5. The liquid crystal display module fixing structure as claimed in claim 4, wherein the first cushion member is made in the form of an elongate strip and is mounted, through adhesive bonding, to a middle portion of the first mounting section, the second cushion member being made in the form of an elongate strip and is mounted, through adhesive bonding, to a middle portion of the second mounting section.

6. The liquid crystal display module fixing structure as claimed in claim 1, wherein the first fixing pieces and the second fixing pieces are each in the form of an n-shaped structure by machining a thin plate.

7. The liquid crystal display module fixing structure as claimed in claim 6, wherein the thin plate is made of aluminum material, steel material, or Bakelite.

8. The liquid crystal display module fixing structure as claimed in claim 2 further comprising a third fixing piece, the third fixing piece comprising an elongate strip like third mounting section and third fixing sections respectively formed on two ends of the third mounting section to be mounted to a middle portion of the liquid crystal display module and fixed to the two ends of the liquid crystal display module.

9. The liquid crystal display module fixing structure as claimed in claim 8, wherein the third fixing sections each comprise a second through hole formed therein to receive the extension of a bolt therethrough so as to fix the third fixing sections to the end faces of the two ends of the liquid crystal display module, the third fixing piece pressing down against the second fixing pieces so as to further secure the second fixing pieces to the liquid crystal display module, the liquid crystal display module comprising a backplane, the backplane comprising threaded holes for mounting a bezel, the bolts that extend through the second through holes threadingly engaging the corresponding threaded holes of the backplane.

10. The liquid crystal display module fixing structure as claimed in claim 8, wherein the third mounting section comprises a third cushion member to provide a cushioning effect when positioned on the liquid crystal display module, the third cushion member being located at the same side of the third mounting section as the third fixing sections are, the third cushion member being made in the form of an elongate strip and mounted, through adhesive bonding, to a middle portion of the third mounting section, the third fixing piece being in the form of an n-shaped structure by machining a thin plate, the thin plate being made of aluminum material, steel material, or Bakelite.

11. A liquid crystal display module fixing structure, which is configured for fixing a liquid crystal display module, wherein the liquid crystal display module comprises two side surfaces formed on two side edges thereof and two end surfaces formed on two end edges thereof, comprising: two first fixing pieces and two second fixing pieces, the first fixing pieces each comprising an elongate strip like first mounting section and first fixing sections respectively formed on two ends of the first mounting section, the second fixing pieces each comprising an elongate strip like second mounting section and second fixing sections respectively formed on two ends of the second mounting section, the first mounting sections of the two first fixing pieces being respectively mounted to the two sides of the liquid crystal display module, the first fixing sections being mounted to the two end faces of the liquid crystal display module, the second mounting sections of the two second fixing pieces being respectively mounted to the two ends of the liquid crystal display module, the second fixing sections being respectively positioned against the two side faces of the liquid crystal display module;
wherein the first fixing sections each comprise a first through hole formed therein to receive the extension of a bolt therethrough so as to fix the first fixing sections to end faces of the two ends of the liquid crystal display module, the two second fixing sections of each of the second fixing pieces being respectively positioned against side faces of the two sides of the liquid crystal display module, the first fixing pieces pressing down against the second fixing pieces so as to fix the second fixing pieces to the liquid crystal display module;
wherein the liquid crystal display module comprises a backplane, the backplane being provided with threaded holes for mounting a bezel, the bolts that extend through the first through holes threadingly engaging the corresponding threaded holes of the backplane;
wherein the first mounting sections each comprise a first cushion member to provide a cushioning effect when positioned on the liquid crystal display module, the first cushion member being located at the same side of the first mounting section as the first fixing sections are, the second mounting sections being each provided with a second cushion member to provide a cushioning effect when positioned on the liquid crystal display module, the second cushion member being located at the same side of the second mounting section as the second fixing sections are;
wherein the first cushion member is made in the form of an elongate strip and is mounted, through adhesive bonding, to a middle portion of the first mounting section, the second cushion member being made in the form of an elongate strip and is mounted, through adhesive bonding, to a middle portion of the second mounting section;
wherein the first fixing pieces and the second fixing pieces are each in the form of an n-shaped structure by machining a thin plate; and
wherein the thin plate is made of aluminum material, steel material, or Bakelite.
